(19) United States
(12) Patent Application Publication
(10) Pub. No.: US 2007/0128946 A1
(43) Pub. Date: Jun. 7, 2007

(54) Connector with protection against electrostatic charges accumulated on a mating connector

(75) Inventors: Kazuhito Hisamatsu, Tokyo (JP); Kazukuni Hisatomi, Tokyo (JP)

Correspondence Address: WILLIAM COLLARD;COLLARD & ROE, P.C., 1077 NORTHERN BOULEVARD, ROSLYN, NY, 11576, US

(73) Assignee: JAPAN AVIATION ELECTRONICS INDUSTRY, LIMITED

(21) Appl. No.: 11/634,549

(22) Filed: Dec. 6, 2006

(30) Foreign Application Priority Data
Dec. 6, 2005 (JP) 2005-352120

(51) Int. Cl. H01R 33/00

(52) U.S. Cl. 439/638

(57) ABSTRACT

In a connector including a fitting portion to be fitted to a mating connector, signal contacts are disposed in the fitting portion in a first row. A ground plate includes a plurality of ground terminals disposed in the fitting portion in a second row parallel to the first row. These contacts are held by a housing. A conductive shell is coupled to the housing and includes a shell body partially covering these contacts, a bent portion bent inward from the shell body at an end of the fitting portion, and a protecting portion extending from the bent portion with a space which is kept between the protecting portion and the shell body. Each of the ground terminals includes a spring portion extending in the fitting portion and a free end portion extending from the spring portion and inserted into the space with being contacted with the protecting portion.

This application claims priority to prior Japanese patent application JP 2005-352120, the disclosure of which is incorporated herein by reference.

### BACKGROUND OF THE INVENTION

This invention relates to a connector adaptable to high-speed transmission.

A connector of the type is required to have a so-called shielding function. For this purpose, a connector disclosed in Japanese Unexamined Patent Application Publication (JP-A) No. H11-283710 comprises, in addition to a signal contact for connecting a signal line, a ground contact for connecting a ground line. The signal contact and the ground contact are held by a housing defining a fitting portion to be fitted to a mating connector. A conductive shell is coupled to an outer surface of the housing. The ground contact has a spring portion disposed in the fitting portion. The spring portion has an end formed as a free end completely separated and apart from the shell.

When the mating connector is fitted to the fitting portion, the mating connector is contacted with the signal contact and the ground contact. As a result, the signal line and the ground line are connected via the mating connector to the signal contact and the ground contact, respectively.

The mating connector starts to contact with the signal contact and the ground contact in the middle of a fitting operation of the mating connector. Therefore, if the mating connector carries electrostatic charges, charge current may flow from the mating connector to the signal contact in the middle of the fitting operation. In case where the signal contact and the ground contact are preliminarily connected to an electric circuit, the charge current flow through the signal contact to the electric circuit. This may result in a damage of the electric circuit.

### SUMMARY OF THE INVENTION

It is therefore an object of this invention to provide a connector having a structure in which, in the middle of a fitting operation of a mating connector, the mating connector is electrically connected to a ground contact before it is contacted with a signal contact.

It is another object of this invention to provide a connector which can be designed to be small in thickness.

It is still another object of this invention to provide a connector which allows a wide displacement of a spring portion of a ground contact.

Other objects of the present invention will become clear as the description proceeds.

According to an aspect of the present invention, there is provide a connector comprising a fitting portion to be fitted to a mating connector in a first direction, a plurality of signal contacts disposed in the fitting portion in a first row extending in a second direction perpendicular to the first direction, a ground plate including a plurality of ground terminals disposed in the fitting portion in a second row parallel to the first row, a housing holding the signal contacts and the ground plate, and a conductive shell coupled to the housing, the shell comprising a shell body partially covering the signal contacts and the ground plate, a bent portion formed at an end of the fitting portion and bent inward from the shell body, and a protecting portion extending from the bent portion along the shell body with a space which is kept between the protecting portion and the shell body in a third direction perpendicular to the first and the second directions, each of the ground terminals including a spring portion extending in the fitting portion along the shell body and a free end portion extending from the spring portion, inserted into the space, and contacted with the protecting portion.

### BRIEF DESCRIPTION OF THE DRAWING

FIGS. 1A to 1D are a plan view, a front view, a bottom view, and a right side view of a connector according to an embodiment of this invention, respectively;

FIG. 2 is a sectional view taken along a line II-II in FIG. 1B;

FIG. 3 is a perspective view of a ground contact of a connector illustrated in FIGS. 1A to 1D; and

FIG. 4 is an enlarged view of a part IV in FIG. 1C.

### DESCRIPTION OF THE PREFERRED EMBODIMENT

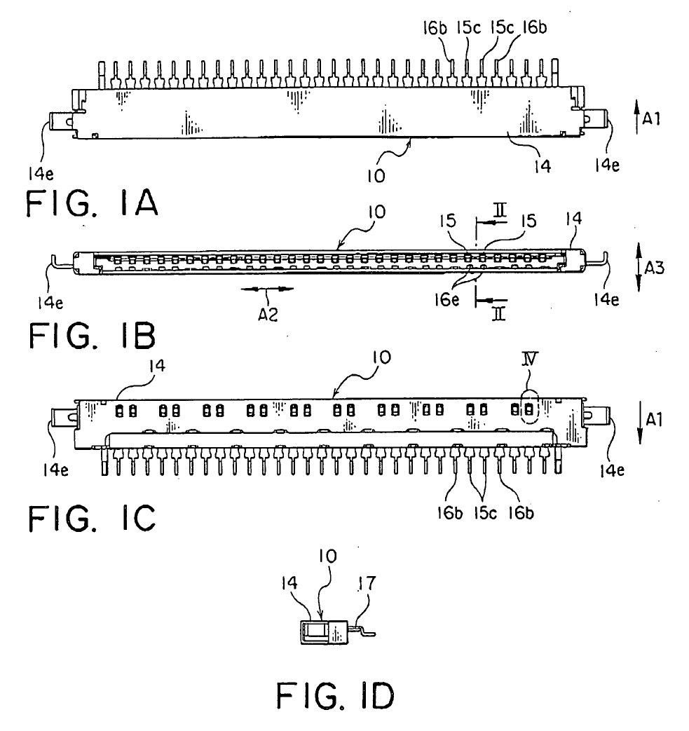

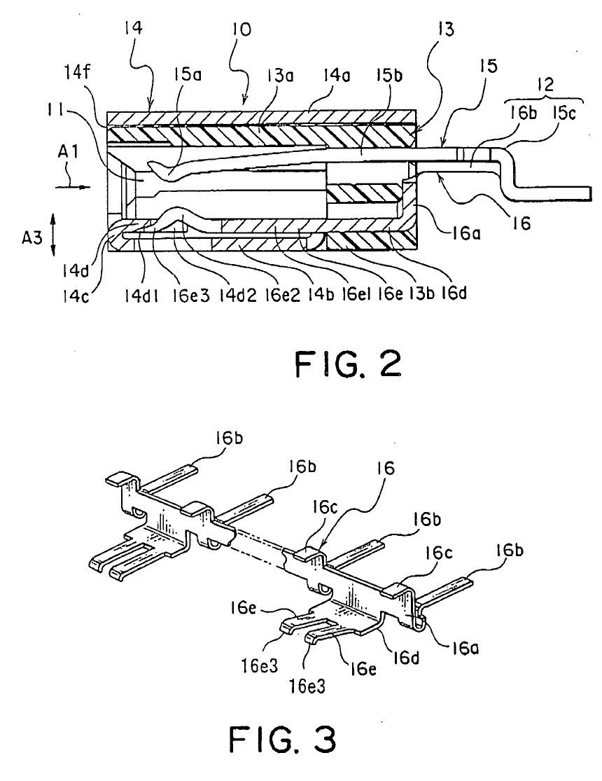

At first referring to FIGS. 1A to 1D and 2, description will be made of an overall structure of a connector according to an embodiment of this invention.

The connector illustrated in the figures is a socket connector and depicted by a reference numeral 10. The socket connector 10 has a fitting portion 11 to be fitted to a mating connector, i.e., a plug connector (not shown) which is inserted to in a first direction A1 as a fitting direction. The socket connector 10 has a connecting portion 12 formed at its rear end to be soldered to a circuit board (not shown). Hereinafter, for convenience of description, one side of the socket connector 10, i.e., the side of the fitting portion 11 will be called a front side and another side of the socket connector 10, i.e., the side of the connecting portion 12 will be called a rear side.

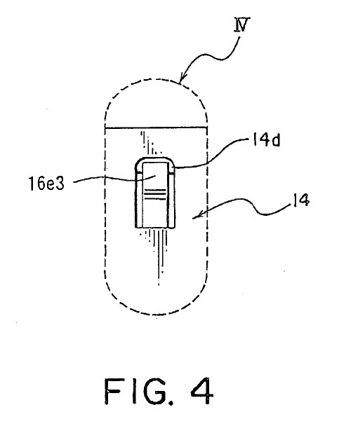

The socket connector 10 comprises an insulator 13 serving as a housing having an L-shaped section, a conductive shell 14 formed around the insulator 13 and defining an outer contour of the socket connector 10, a plurality of conductive signal contacts 15 implanted on the insulator 13, and a conductive ground plate 16 formed by punching and press-forming a single conductive plate as shown in FIG. 4.

The insulator 13 has a ceiling plate 13a and a bottom plate 13b formed adjacent the rear end of the socket connector 10 and integrally connected to the ceiling plate 13a. The signal contacts 15 are implanted between the ceiling plate 13a and the bottom plate 13b. The ground plate 16 is inserted between the ceiling plate 13a and the bottom plate 13b in a direction opposite to the first direction A1 so as not to be contacted with the signal contacts 15.

The shell 14 has a box-like shape and has an opening 14f formed its front end. The shell 14 comprises a top plate 14a covering the insulator 13 and a bottom plate 14b opposite to the top plate 14a. The shell 14 electrically has a ground function. A combination of the top plate 14a and the bottom plate 14b forms a shell body partially covering the signal contacts 15 and the ground plate 16.

The shell 14 further comprises a bent portion 14c formed at the front end and bent inward and upward from the bottom plate 14b, and a protecting portion 14d extending from the bent portion 14c along the bottom plate 14b with a space which is kept between the protecting portion 14d and the bottom plate 14b. The bent portion 14c is gently curved or rounded to guide the mating connector to the fitting portion 11. The bent portion 14c serves to increase a mechanical strength of a front end portion of the socket connector 10.

The shell 14 further comprises a pair of substrate fixing portions 14e formed at opposite ends thereof in a second direction A2 perpendicular to the first direction A1 and protruding in a U shape. The substrate fixing portions 14e serve as solder fixing portions to the circuit board.

The signal contacts 15 are arranged in the fitting portion 11 in a first row extending in the second direction A2. Each of the signal contacts 15 has spring elasticity and has a thin, long plate-like shape adapted to impedance matching. Each of the signal contacts 15 has a contacting portion 15a having one end received in the fitting portion 11 and bent in an angled shape to be contacted with a mating contact, a supporting portion 15b extending from the contacting portion 15a rearward of the socket connector 10 and fixed and supported by the insulator 13, and a soldering terminal portion 15c extending from the supporting portion 15b rearward and outward of the socket connector 10 in the first direction A1, bent downward to extend in a third direction A3 perpendicular to the first and the second directions A1 and A2, further bent in the first direction A1, and horizontally extending to be soldered to the circuit board. Thus, the signal contact 15 has a plate-like simple structure and, therefore, can easily be impedance-matched.

Referring to FIG. 3 in addition to FIG. 2, the ground plate 16 will be described.

The ground plate 16 has a connecting portion 16a extending in the second direction A2, a plurality of connecting terminals or soldering terminal portions 16b bent from the connecting portion 16a and extending rearward, a plurality of fixing portions 16c formed at positions corresponding to the soldering terminal portions 16b, extending upward from the connecting portion 16a and bent frontward to be fixed to the insulator 13, a plurality of contact base portions 16d having spring elasticity and formed at positions between adjacent ones of the soldering terminal portions 16b on the side opposite to the soldering terminal portions 16b, and a plurality of pairs of ground terminals 16e, each pair extending frontward from each contact base portion 16d. The connecting portion 16a is held by the insulator 13. The soldering terminal portions 16b are exposed outside of the insulator 13 as connecting terminals.

Each of the ground terminals 16e has a spring portion 16e1 extending in the fitting portion 11 along the bottom plate 14b of the shell 14, a contacting portion 16e2 disposed in the fitting portion 11 and faced to the contacting portion 15a of the signal contact 15 in the third direction A3, and a free end portion 16e3 extending from the spring portion 16e1 and inserted into a space between the bottom plate 14b and the protecting portion 14d. The free end portion 16e3 is urged by elastic restoring force of the spring portion 16e1 to be brought into contact with the protecting portion 14d. Therefore, in the state where the socket connector 10 is not fitted to the mating connector, the socket connector 10 is electrically connected to the ground plate 16. The ground terminals 16e are entirely disposed inside the shell body.

As described above, in the fitting portion 11, the contacting portions 16e2 of the ground terminals 16e are faced to the contacting portions 15a of the signal contacts 15 in the second direction A2, respectively. A pair of adjacent ones of the contacting portions 15a of the signal contacts 15 are used to transmit a pair of differential signals. Hereinafter, a pair of signal contacts 15 will be called a signal contact pair.

On the other hand, at the connecting portion 12 on the side opposite to the fitting portion 11 of the socket connector 10, the soldering terminal portions 15c of the signal contact pair are disposed between adjacent ones of the soldering terminal portions 16b of the ground plate 16. Thus, at the connecting portion 12 of the socket connector 10, the soldering terminal portions 16b of the ground plate 16 and the soldering terminal portions 15c of the signal contacts 15 are arranged on a same plane in a single row in the second direction A2. Therefore, it is easy to connect the soldering terminal portions 16b and the soldering terminal portions 15c to the circuit board, for example, by soldering.

At the connecting portion 12 of the socket connector 10, the soldering terminal portions 16b of the ground plate 16 are arranged adjacent to the soldering terminal portions 15c of the signal contact pair. Therefore, a pair of differential signals can be dealt with in a good condition.

Referring to FIG. 4 in addition to FIG. 2, description will be made of the protecting portion 14d and the free end portion 16e3 in detail.

The free end portion 16e3 is small in thickness in the third directionA3 as compared with the spring portion 16e1 and the contacting portion 16e2. The protecting portion 14d has a slope 14d1 for guiding insertion of the free end portion 16e3 into the space. Preferably, an upper surface of the free end portion 16e3 has an inclination equivalent to the slope 14d1 in order to widen a contact area between the protecting portion 14d and the free end portion 16e3. The protecting portion 14d is provided with a cut portion 14d2 for guiding and allowing vertical movement of the contacting portion 16e2 of the ground terminal 16e. Thus, the cut portion 14d2 protects the contacting portion 16e2 of the ground terminal 16e.

Next referring to FIG. 2, description will be made of connection of the socket connector 10 and the mating connector.

The mating connector is fitted to the fitting portion 11 of the socket connector 10 in the first direction A1. At the start of the fitting operation, the mating connector is guided by the curved bent portion 14c of the shell 14 in frictional contact therewith and is at first contacted with the protecting portion 14d of the shell 14. The ground plate 16 is electrically connected to the protecting portion 14d of the shell 14. Therefore, even if the mating connector carries electrostatic charges, charge current flows through the ground plate 16 and does not flow to the signal contacts 15. The free end portion 16e3 is hidden below the protecting portion 14d. Therefore, when the mating connector is fitted to the socket connector 10, the free end portion 16e3 is not pushed by the mating connector in the first direction A1. Therefore, the ground plate 16 is hardly pushed rearward of the socket connector 10.

When the mating connector is further moved in the first direction A1, the contacting portions 15a and 16e2 of the signal contact 15 and the ground terminal 16e are displaced away from each other by the mating connector. Since the free end portion 16e3 is small in thickness, the displacement of the contacting portion 16e2 of each ground terminal 16e can be increased.

When the mating connector is completely fitted to the fitting portion 11 of the socket connector 10, the contacting portion 15a of the signal contact 15 and the contacting portion 16e2 of the ground terminal 16e are contacted with the mating connector. Therefore, connection of the signal line and the ground line is achieved. Each component is designed so that an end portion of the ground terminal 16e does not protrude below a lower surface of the bottom plate 14b of the shell 14 upon fitting or in a fitted state.

While the present invention has thus far been described in connection with the preferred embodiment thereof, it will readily be possible for those skilled in the art to put this invention into practice in various other manners.

What is claimed is:

1. A connector comprising:
a fitting portion to be fitted to a mating connector in a first direction;
a plurality of signal contacts disposed in the fitting portion in a first row extending in a second direction perpendicular to the first direction;
a ground plate including a plurality of ground terminals disposed in the fitting portion in a second row parallel to the first row;
a housing holding the signal contacts and the ground plate; and
a conductive shell coupled to the housing;
the shell comprising:
a shell body partially covering the signal contacts and the ground plate;
a bent portion formed at an end of the fitting portion and bent inward from the shell body; and
a protecting portion extending from the bent portion along the shell body with a space which is kept between the protecting portion and the shell body in a third direction perpendicular to the first and the second directions;
each of the ground terminals including:
a spring portion extending in the fitting portion along the shell body; and
a free end portion extending from the spring portion, inserted into the space, and contacted with the protecting portion.

2. The connector according to claim 1, wherein the free end portion is small in thickness in the third direction as compared with the spring portion.

3. The connector according to claim 1, wherein the ground terminals are entirely disposed inside the shell body.

4. The connector according to claim 1, wherein the protecting portion has a slope for guiding insertion of the free end portion into the space.

5. The connector according to claim 1, wherein the protecting portion has a cut portion formed at a position corresponding to each of the ground terminal to guide a part of the ground terminal near the free end portion.

6. The connector according to claim 1, wherein the ground plate further includes a connecting portion connecting the ground terminals to one another, the connecting portion being held by the housing.

7. The connector according to claim 6, wherein the ground plate has a plurality of connecting terminals extending from the connecting portion on the side opposite to the ground terminals, the connecting terminals being exposed outside the housing.

8. The connector according to claim 7, wherein each of the signal contacts extends on the side opposite to the fitting portion to be exposed outside and is disposed between adjacent ones of the connecting terminals.

9. The connector according to claim 1, wherein the signal contacts and the ground terminals have contacting portions faced to each other in the fitting portion.
